(19) United States
(12) Patent Application Publication
(10) Pub. No.: US 2015/0229591 A1
(43) Pub. Date: Aug. 13, 2015

(54) MESSAGING TRANSLATION SYSTEMS AND METHODS

(71) Applicant: Lingo Flip LLC, Milford, CT (US)

(72) Inventors: Douglas Joseph VIGLIOTTI, Hamden, CT (US); Amanda DAVID, Milford, CT (US); Michael Louis Cote, Milford, CT (US)

(21) Appl. No.: 14/618,098

(22) Filed: Feb. 10, 2015

Related U.S. Application Data
(60) Provisional application No. 61/937,999, filed on Feb. 10, 2014.

(51) Int. Cl. H04L 12/58; H04L 29/08; G06F 17/28

(52) U.S. Cl. CPC H04L 51/046; G06F 17/2845; H04L 67/306

(57) ABSTRACT

A system includes a non-transitory machine readable storage medium and a processor in communication with the non-transitory machine readable storage medium. The processor is configured to determine if a first message received from a first computing device intended for a second computing device includes a first communication to be translated. If the first communication is to be translated, the processor is configured to cause a second message to be generated based on the first message. The second message includes a second communication in the form of a translated version of the first communication. The processor is configured to cause one of the first message and the second message to be transmitted to the second computing device. At least one of the first communication and the translated version of the first communication is to be displayed to a user of the second computing device.

### CROSS-REFERENCE TO RELATED APPLICATIONS

This application claims priority to U.S. Provisional Patent Application No. 61/937,999, filed Feb. 10, 2014, the entirety of which is incorporated by reference herein.

### BACKGROUND

The disclosed systems and methods relate to electronic communication. More particularly, the disclosed systems and methods relate to translating electronic communications in real-time.

Various methods of electronic communication are available today. For example, electronic mail (“email”), text (e.g., short message service (“SMS”)) messaging, and various chat messaging programs enable people to communicate with others in a variety of ways. Email typically is reserved for more robust communications compared to text messaging and chat programs. Text messaging and chat programs typically are used for more real-time communication between people, whereas email usually is not the electronic communication method of choice for such “real-time” communication.

### SUMMARY

In some embodiments, a system includes a non-transitory machine readable storage medium and a processor in communication with the non-transitory machine readable storage medium. The processor is configured to determine if a first message received from a first computing device intended for a second computing device includes a first communication to be translated. If the first communication is to be translated, the processor is configured to cause a second message to be generated based on the first message. The second message includes a second communication in the form of a translated version of the first communication. The processor is configured to cause one of the first message and the second message to be transmitted to the second computing device. At least one of the first communication and the translated version of the first communication is to be displayed to a user of the second computing device.

In some embodiments, a method includes receiving a first message from a first computing device, and determining, at a third computing device, if the first message includes a first communication to be translated. The first message is intended for a second computing device. If the first communication is to be translated, a second message based on the first message is generated at the third computing device. The second message includes a translated version of the first communication. One of the first message and the second message is transmitted from the third computing device to the second computing device. At least one of the first communication and the translated version of the first communication is to be displayed to a user of the second computing device.

### BRIEF DESCRIPTION OF THE DRAWINGS

FIG. 1A illustrates one example of a communication network including a translation communication system in accordance with some embodiments.

FIG. 1B is a block diagram of one example of the components of a computing device, such as a mobile device, in accordance with some embodiments.

FIG. 2A illustrates one example of a first graphical user interface in accordance with some embodiments.

FIG. 2B illustrates one example of a graphical user interface for registering with a system in accordance with some embodiments.

FIG. 2C illustrates one example of a graphical user interface displaying contacts in accordance with some embodiments.

FIG. 2D illustrates one example of a graphical user interface for adding a contact in accordance with some embodiments.

FIG. 2E illustrates one example of a graphical user interface displaying communications, including translated communications, in accordance with some embodiments.

FIG. 3 is a flow diagram of one example of a method of providing translated communications in real time in accordance with some embodiments.

FIG. 4 is a flow diagram of another example of a method of providing translated communications in real time in accordance with some embodiments.

FIGS. 5A and 5B are block diagrams of examples of data structures for messages including a communication in accordance with some embodiments.

### DETAILED DESCRIPTION

This description of the exemplary embodiments is intended to be read in connection with the accompanying drawings, which are to be considered part of the entire written description.

Electronic communications are used frequently by people who all speak a common language. However, electronic communication becomes more difficult when people do not speak the same language. This is especially true when the electronic communication is a “real-time” communication in which people want to have a conversation as conventional electronic communication platforms do not provide for translating text between one or more different languages.

The disclosed systems and methods advantageously enable electronic communication between people using language translation. As described in greater detail below, in some embodiments, the translation is provided for “real-time” communication between users. In some embodiments, the real-time communication is provided using an intermediate processing device that stores user profiles, determines if communications included in messages transmitted between users need to be translated, and facilitates the translation of communications by accessing a database and/or a third-party translation service. In some embodiments, an intermediate processing device is configured to examine data structures to determine if communications included in messages being transmitted between two communicating devices are to be translated. The use of the data structures advantageously reduces the amount of processing required to facilitate the communication between different users. These and other advantages will be apparent to those of ordinary skill in the art.

As described in greater detail below, the disclosed systems, devices, and methods are implemented over networks such as, for example, the Internet. The Internet is a worldwide system of computer networks—a network of networks in which a user at one computer, terminal, or other device connected to the network can obtain information from any other computer, terminal, or device and communicate with users of other computers or devices. The most widely used part of the Internet is the World Wide Web (often-abbreviated “WWW” or called “the Web”). Using the Web provides access to millions of pages of information. Web “surfing” is done with a Web browser such as, for example, Apple Safari, Microsoft Internet Explorer, Mozilla Firefox, and Google Chrome. The appearance of a particular website may vary slightly depending on the particular browser used. Versions of browsers have “plug-ins,” which provide animation, virtual reality, sound, and music. Interpreted programs (e.g., applets) may be run within the browser.

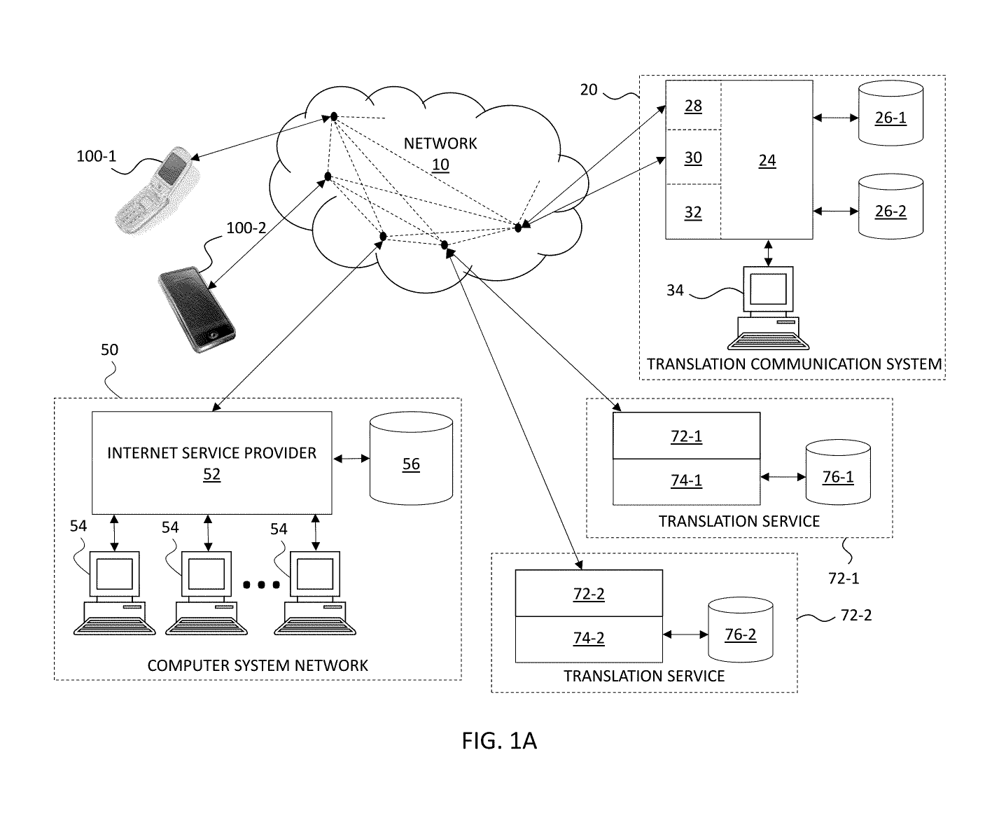

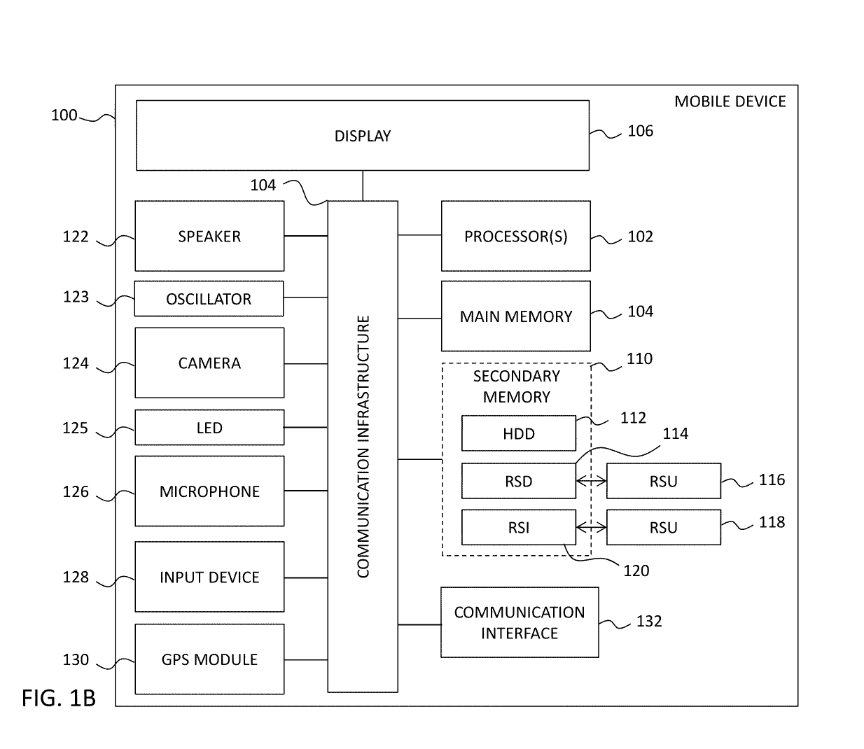

FIG. 1A depicts one example of a system in which a plurality of wireless devices 100-1 and 100-2 (collectively “wireless devices 100” or “mobile devices 100”) are connected via network 10 to one or more computer system networks 50-1, 50-2 (“computer networks 50”), and to communication translation system 20. Network 10 may be a wide area network (“WAN”), a local area network (“LAN”), personal area network (“PAN”), or the like. In one embodiment, network 10 is the Internet and mobile devices 100 are online. “Online” may mean connecting to or accessing source data or information from a location remote from other devices or networks coupled to network 10.

System 20 includes a processing unit 24, which can include on or more processors, coupled to one or more data storage units 26-1, 26-2 (collectively referred to as “data storage units 26”). The processing unit 24, in some embodiments, is configured to provide front-end graphical user interfaces (“GUIs”), e.g., a prison user GUI 28, a call center GUI 30, and a back-end or administrative GUI or portal 32 to one or more remote computers 54 or to one or more local computers 34. In some embodiments, a physician interface (not shown) is provided and/or a physical accesses system 20 via GUI 28. The GUIs can take the form of, for example, a webpage that is displayed using a browser program local to remote computers 54 or to one or more local computers 34. It is understood that the system 20 may be implemented on one or more computers, servers, or other computing devices. For example, system 20 may include servers programmed or partitioned based on permitted access to data stored in data storage units 26. Front- and back-end GUIs 28, 30, 32 may be portal pages that include various content retrieved from the one or more data storage devices 26. As used herein, “portal” is not limited to general-purpose Internet portals, such as YAHOO! or GOOGLE but also includes GUIs that are of interest to specific, limited audiences and that provide the party access to a plurality of different kinds of related or unrelated information, links and tools as described below. “Webpage” and “website” may be used interchangeably herein.

Remote computers 54 may be part of a computer system network 502 and gain access to network 10 through an Internet service provider (“ISP”) 52. Mobile devices 100 may gain access to network 10 through a wireless cellular communication network, a WAN hotspot, or through a wired or wireless connection with a computer as will be understood by one skilled in the art.

One or more translation services 70-1, 70-2 (collectively “translation services 70”) also are connected to network 10. Translation services 70 each includes a respective application programming interface (“API”) 72 (i.e., APIs 72-1, 72-2), a processing device 74 (i.e., processing devices 74-1, 74-2), and a data storage device 76 (i.e., data storage devices (76-1, 76-2). As described in greater detail below, translation communication system 20 may access translation data stored in a data storage device 76 via network 10 and an API 72.

In one embodiment, mobile devices 100 includes any mobile device capable of transmitting and receiving wireless signals. Examples of mobile instruments include, but are not limited to, mobile or cellular phones, personal digital assistants (“PDAs”), laptop computers, tablet computers, music players, and e-readers, to list only a few possible devices.

FIG. 1B is a block diagram of one example of an architecture of mobile device 100. As shown in FIG. 1B, mobile device 100 includes one or more processors, such as processor(s) 102. Processor(s) 102 may be any central processing unit (“CPU”), microprocessor, micro-controller, or computational device or circuit for executing instructions. Processor(s) are connected to a communication infrastructure 104 (e.g., a communications bus, cross-over bar, or network). Various software embodiments are described in terms of this exemplary mobile device 100. After reading this description, it will be apparent to one of ordinary skill in the art how to implement the method using mobile devices 100 that include other systems or architectures. One of ordinary skill in the art will understand that computers 34, 54 may have a similar and/or identical architecture as that of mobile devices 100. Put another way, computers 34, 54 can include some, all, or additional functional components as those of the mobile device 100 illustrated in FIG. 1B.

Mobile device 100 includes a display 106 that displays graphics, video, text, and other data received from the communication infrastructure 104 (or from a frame buffer not shown) to a user. Examples of such displays 106 include, but are not limited to, LCD screens, OLED display, capacitive touch screen, and a plasma display, to list only a few possible displays. Mobile instrument 100 also includes a main memory 108, such as a random access (“RAM”) memory, and may also include a secondary memory 110. Secondary memory 110 may include a more persistent memory such as, for example, a hard disk drive (“HDD”) 112 and/or removable storage drive (“RSD”) 114, representing a magnetic tape drive, an optical disk drive, solid state drive (“SSD”), or the like. In some embodiments, removable storage drive 114 reads from and/or writes to a removable storage unit (“RSU”) 116 in a manner that is understood by one of ordinary skill in the art. Removable storage unit 116 represents a magnetic tape, optical disk, or the like, which may be read by and written to by removable storage drive 114. As will be understood by one of ordinary skill in the art, the removable storage unit 116 may include a tangible and non-transient machine readable storage medium having stored therein computer software and/or data.

In some embodiments, secondary memory 110 may include other devices for allowing computer programs or other instructions to be loaded into mobile device 100. Such devices may include, for example, a removable storage unit (“RSU”) 118 and a corresponding interface (“RSI”) 120. Examples of such units 118 and interfaces 120 may include a removable memory chip (such as an erasable programmable read only memory (“EPROM”)), programmable read only memory (“PROM”)), secure digital (“SD”) card and associated socket, and other removable storage units 118 and interfaces 120, which allow software and data to be transferred from the removable storage unit 118 to mobile device 100.

Mobile device 100 may also include a speaker 122, an oscillator 123, a camera 124, a light emitting diode (“LED”) 125, a microphone 126, an input device 128, and a global positioning system (“GPS”) module 130. Examples of input device 128 include, but are not limited to, a keyboard, buttons, a trackball, or any other interface or device through a user may input data. In some embodiment, input device 128 and display 106 are integrated into the same device. For example, display 106 and input device 128 may be touchscreen through which a user uses a finger, pen, and/or stylus to input data into mobile instrument 100.

Mobile device 100 also includes one or more communication interfaces 132, which allows software and data to be transferred between mobile device 100 and external devices such as, for example, another mobile device 100, a computer 34, 54 and other devices that may be locally or remotely connected to mobile device 100. Examples of the one or more communication interfaces 132 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express (“PCIE”) slot and cards, or any combination thereof. The one or more communication interfaces 132 may also include a wireless interface configured for short range communication, such as near field communication (“NFC”), Bluetooth, or other interface for communication via another wireless communication protocol. As briefly noted above, one of ordinary skill in the art will understand that computers 34, 54 and portions of system 20 may include some or all components of mobile device 100.

Software and data transferred via the one or more communications interfaces 132 are in the form of signals, which may be electronic, electromagnetic, optical, or other signals capable of being received by communications interfaces 132. These signals are provided to communications interface 132 via a communications path or channel. The channel may be implemented using wire or cable, fiber optics, a telephone line, a cellular link, a radio frequency (“RF”) link, or other communication channels.

In this document, the terms “non-transitory computer program medium,” “non-transitory computer readable medium,” and “non-transitory machine readable storage medium” refer to media such as removable storage units 116, 118, or a hard disk installed in hard disk drive 112. These computer program products provide software to mobile device 100. Computer programs (also referred to as “computer control logic”) may be stored in main memory 108 and/or secondary memory 110. Computer programs may also be received via the one or more communications interfaces 132. Such computer programs, when executed by a processor(s) 102, enable the mobile device 100 to perform the features of the method discussed herein.

In an embodiment where the method is partially or entirely implemented using software, the software may be stored in a computer program product and loaded into mobile device 100 and/or system 20 using removable storage drive 114, hard drive 112, and/or communications interface 132. The software, when executed by processor(s) 102, causes the processor(s) 102 to perform the functions of the method described herein. In another embodiment, the method is implemented primarily in hardware using, for example, hardware components such as application specific integrated circuits (“ASICs”). Implementation of the hardware state machine so as to perform the functions described herein will be understood by persons skilled in the art. In yet another embodiment, the method is implemented using a combination of both hardware and software.

In some embodiments, mobile device 100 downloads an application (“app”) from a webstore, such as Google Play, the Apple App Store, to list only a couple possibilities, and the application is stored in memory, such as main memory 104. The downloaded app includes instructions executed by processor(s) 102, which causes a number of GUIs to be displayed on display 106. Further, the downloaded app includes instructions for processor(s) 102 to cause mobile device 100 to communicate with system 20, one or more translation services 70, and/or a one or more computer system networks 50. Although the following description describes structures and functions being performed by mobile device 100, one of ordinary skill in the art will understand that the following descriptions pertain to a computers 54.

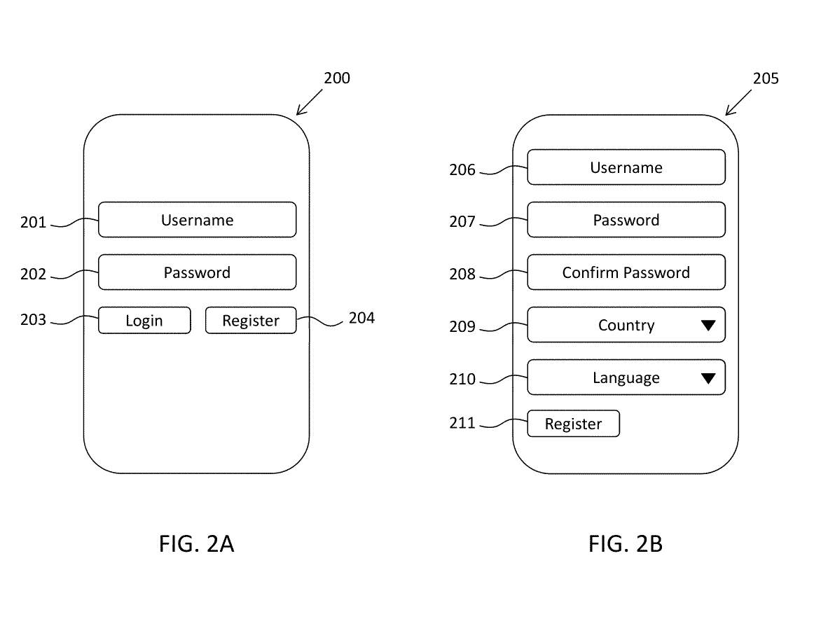

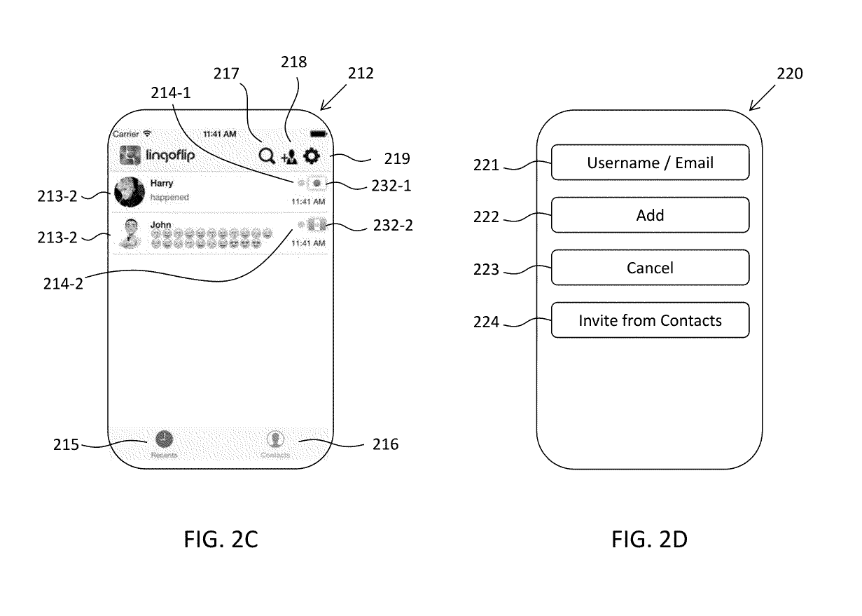

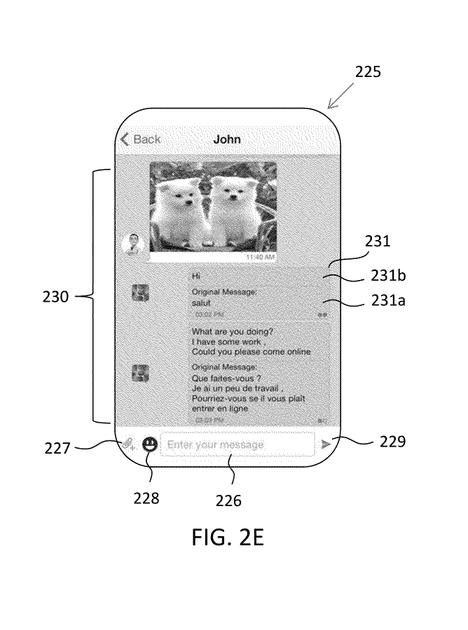

Turning now to FIG. 2A, when a user launches the app after it is downloaded, the user is presented with a login screen, such as GUI 200. The login screen prompts the user to either register with system 20 or to login by entering the user's username in text entry field 201, the associated password in text entry field 202, and clicking login button 203 or to register with system 20 by clicking register button 204.

If the register button 204 is selected, then another GUI is displayed to the user. FIG. 2B illustrates one example of a registration GUI 205 in accordance with some embodiments. As shown in FIG. 2B, GUI 205 includes text entry fields 206, 207 for entering a selected username and password. GUI 205 also includes a text entry field 208 in which the user is to reenter the chosen password to confirm the password entered in text entry field 207. A pair of dropdown menus 209, 210 also are provided for providing the user with the ability to select the country in which the user resides and the user's language. When the user has entered the information requested by GUI 205, the register button 211 is selected and the information entered into GUI 205 is encrypted and transmitted to system 20. System 20 creates a user account in one or more data storage units 26 such that the username is associated with the password, the user's country of residence, and the language preference. The user is now registered with system 20 and is able to use the app running on a mobile device 100 and/or computer 54 to communicate with other registered users logged into system and/or running the app.

Referring again to FIG. 2A, if the login button 203 is selected with the username and password having been entered into fields 201 and 202, then, in some embodiments, the entered username and password are encrypted and transmitted to system 20 via network 10 shown in FIG. 1A. Processing unit 24 receives the encrypted data from mobile device 100 and determines if the username and password match a registered user by searching one or more data storage units 26 as will be understood by one of ordinary skill in the art. If system 20 (and more particularly processing unit 24) determines that the user is registered, it transmits a message to mobile device 100 identifying that the user is registered.

In some embodiments, once the login process is completed the user is presented with a list of contacts. One example of a GUI 212 presenting the user's list of contacts is illustrated in FIG. 2C. As shown in FIG. 2C, GUI 212 includes contact entries 213-1, 213-2 (collectively “contact entries 213”), which also include status indicators 214-1, 214-2 (collectively “status indicators 214”). In some embodiments status indicators identifying if the contact is online, available to chat, busy, or away. One of ordinary skill in the art will understand that status indicators 214 can identify other status types.

GUI 212 also includes a recent contact button 215 and an all contacts button 216 such that the user can toggle between the contacts with whom the user recently communicated and a list of all contacts. In some embodiments, the upper right corner of GUI 212 includes a search icon 217, an add contact icon 218, and a settings icon 219. Search icon 217, if selected, presents the user with a text entry field (not shown) such that the user can enter in one or more alphanumeric characters to search for a particular contact.

The add contact icon 218, if selected, presents the user with a contact creation GUI (not shown) in which the user can add a contact to the user's list of contacts. One example of such a contact creation GUI 220 is illustrated in FIG. 2D. As shown in FIG. 2D, GUI 220 includes a text entry field 221 in which a user can enter a username or email address for the contact the user would like to add. An add button 222 and a cancel button 223 also are provided such that the user can add the contact given the information entered into text entry field 221 or can cancel the process of adding a contact, respectively. Another button 224 is provided such that the user can invite a contact based on another list of contacts, such as from an address book stored on mobile device 100 and/or in another app as will be understood by one of ordinary skill in the art.

Referring again to FIG. 2C, a user can communicate with one or more contacts by selecting the desired contact entry 213 by using an input device, such as a stylus, finger, mouse, to list only a few possibilities. When a contact entry 213 is selected, another GUI is displayed to a user such that the user is able to communicate with the contact via electronic messaging in real time. One example of a communication GUI in accordance with some embodiments is GUI 225 illustrated in FIG. 2E.

As shown in FIG. 2E, GUI 225 includes a text entry field 226 for entering a message using a virtual keyboard (not shown) presented to a user. The type of virtual keyboard displayed to the user is based on the country and language values provided by the user during the login procedure as described above with respect to FIGS. 2A and 2B. For example, if the user enters “United States of America” in pull-down menu 209 and “English” in pull-down menu 210, then the virtual keyboard displayed to the user for entering text in text entry field 226 in GUI 225 in FIG. 2E will be a customary keyboard used in the United States. However, if the user enters “Japan” in pull-down menu 209 and “Japanese” in pull-down menu 210, then the virtual keyboard displayed to the user for entering text in text entry field 226 in FIG. 210 is a customary keyboard used in Japan. One of ordinary skill in the art will understand that the number of languages, countries, and keyboard types supported by the app and system 20 can vary and are not limited. Users can update their language preferences using the settings button 219 shown in FIG. 2C as will be understood by one of ordinary skill in the art.

Referring again to FIG. 2E, an attachment button 227, an emoticon button 228, and a send button 229 also are provided for customizing a communication and transmitting a message to the contact. GUI 225 also includes an area 230 displaying previously transmitted and received communication, which can include text and images.

Advantageously, the communications in area 230 are displayed in accordance with the user's preferences regardless of the language used by the contact with whom the user is communicating. For example, if the user enters is an English speaker from the United States, then the communications displayed as having been transmitted to and received from the contact are displayed in English even if the contact with whom the user is communicating is typing using a customary Japanese keyboard and entering text in Japanese (e.g., katakana and/or hiragana). The translation between languages is performed in real-time by system 20 such that there is a minimal delay in sending a message from one mobile device 100 and displaying a communication on the other mobile device 100.

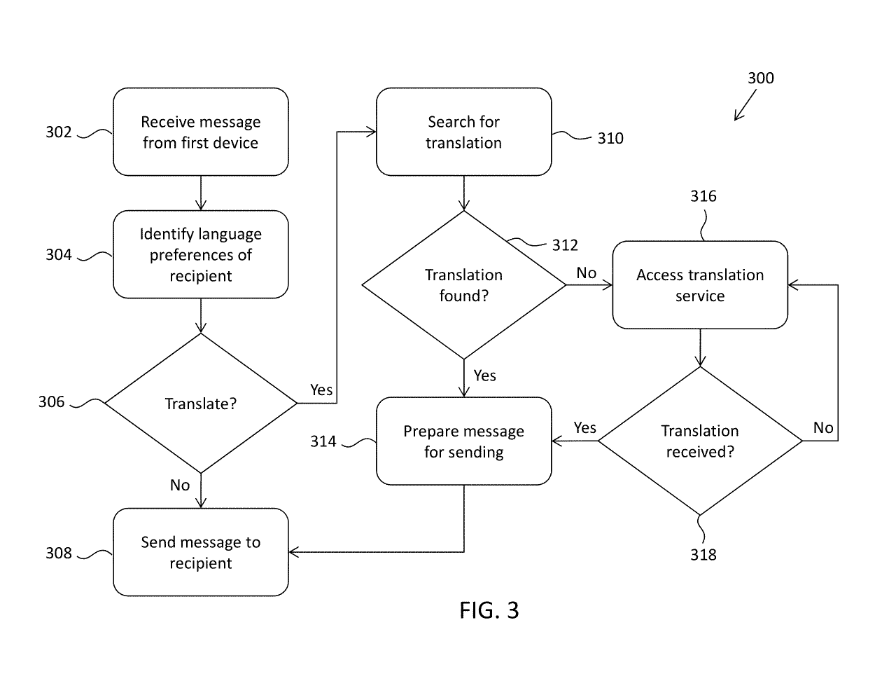

One example of a method of translating communications in real-time using system 20 is now described with reference to FIG. 3, which is a flow diagram of one example of a method 300. At block 302, system 20 receives a message from a first mobile device, e.g., mobile device 100-1 in FIG. 1A, to be transmitted to at least one second mobile device, e.g., mobile device 100-2 in FIG. 1A. The message received at system 20 from mobile device 100-1 includes the user-entered message or communication, i.e., text entered by a user of mobile device 100-1 in text entry field 226 and/or data identified using attachment button 227 or emoticon button 228 of GUI 225 (FIG. 2E). In some embodiments, the received message also includes one or more data structures identifying the sender of the message, the intended recipient of the message, and other pertinent information for relaying the message to a recipient and causing the proper communication to be displayed.

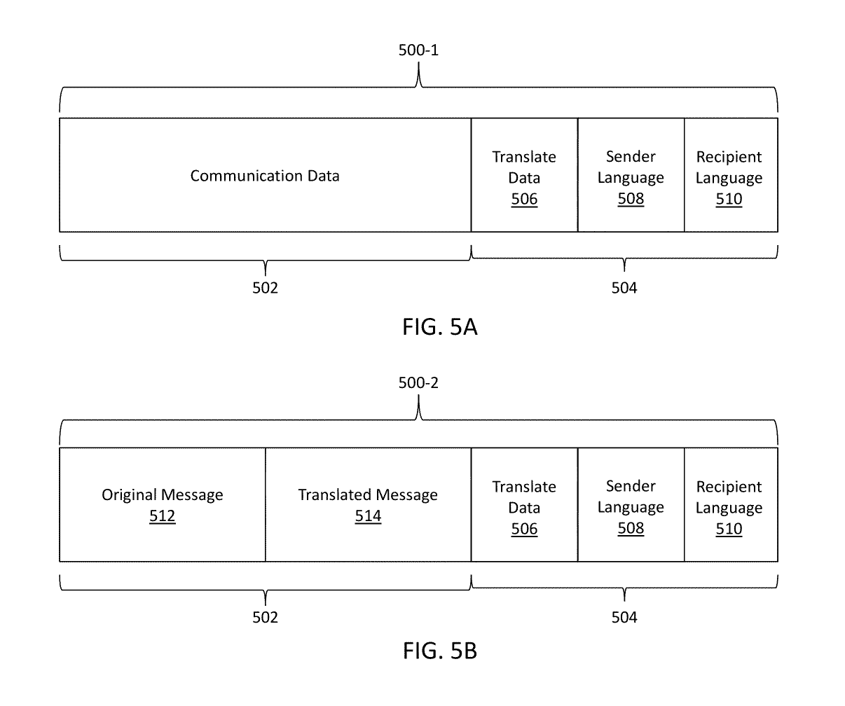

For example, FIGS. 5A and 5B illustrates examples of message 500-1, 500-2 in accordance with some embodiments. As shown in FIG. 5A, message 500 includes communication data portion 502, such as the text and/or other user-added data (e.g., picture, song file, emoticon, etc.), and a protocol data structure portion 504. In some embodiments, protocol data structure portion 504 includes a translation data portion 506, which identifies if the communication data is to be translated, a sender language portion 508, which identifies the language preference of the sender, and a recipient language portion 510, which identifies the language preference of the recipient. As described in greater detail below, one or more portions of the data structure portion 504 can be updated by a mobile device 100, computer 54, and/or system 20.

Referring again to FIG. 3, the recipient information included in the message received from mobile device 100-1 is used to identify the recipient's language preferences at block 304. For example, in some embodiments, processing device 24 of system 20 accesses the profile stored in one or more data storage devices 26 to identify the language preferences associated with the recipient's profile. In some embodiments, the language preference of the recipient is included in a data structure included in the received message. As described in more detail below, system 20 can be configured to update data structure portion 504 included in the electronic messages 500 transmitted between communicating devices (e.g., mobile devices 100 and computers 54) to reduce processing of exchanged messages.

At decision block 306, processing device 24 determines if a communication included in the message received from mobile device 100-1 intended from mobile device 100-2 is to be translated. In some embodiments, the determination as to whether the communication is to be translated is made based on whether the sender's language preference matches the recipient's language preference according to the profiles stored in data storage devices 26. In some embodiments, the determination as to whether the communication is to be translated is based on the sender's language preference, which is included in sender language portion 508 of protocol data structure portion 510 in the received message 500 (FIG. 5), and the recipient's language preference stored in one or more data storage devices 26 (FIG. 1A).

In some embodiments, the determination as to whether a communication included in a message is to be translated is based on one or more bits included in the protocol data structure portion 504 of message 500 received from mobile device 100-1. For example, the message received from mobile device 100-1 may include a bit that signals whether or not the communication included in the message is to be translated, i.e., translate data 506 (FIGS. 5A and 5B), based on prior messaging between mobile device 100-1 and mobile device 100-2. In some embodiments, system 20 updates one or more bits to the first message transmitted between two users once system 20 determines that messages between the communicating users, which can include two or more users, are to be translated based on a previous determination made by system 20. The bit(s) or flag(s) set by system 20 is included in future messages between the two or more users to reduce ongoing processing requirements of system 20 and to increase the speed at which the messages are transmitted between users.

In some embodiments, the bits of a data structure, e.g., protocol data structure portion 504 in FIGS. 5A and 5B, identifying whether a communication are configured to be updated by the communicating devices. For example, if a conversation is continuing uninterrupted, e.g., each user of a mobile 100 does not move away from communication GUI 225 as messages exchanged, then the mobile device will not update protocol data structure portion 504 of message 500 (FIGS. 5A and 5B) to signal system 20 that the user profiles should be checked to confirm whether the prior stored information concerning whether communications should be translated and/or the language preferences should be checked. In some embodiments, a user moving away from communication GUI 225 will cause the mobile device 100 to update the protocol data structure portion 504 of message 500 (FIGS. 5A and 5B) because a user could update his/her language preferences by navigating away from GUI 225 and accessing the account settings via settings button 219 as shown in FIG. 2C.

Referring again to FIG. 3, if the communication is not to be translated, i.e., the No branch is taken at decision block 306, then the original (untranslated) communication is transmitted in a message to the recipient via network 10 at block 308. The untranslated communication is then displayed to the recipient, e.g., user of mobile device 100-2, as entered by the user of mobile device 100-1.

If the communication is to be translated, i.e., the Yes branch of decision block 306 is taken, then system 20 moves to block 310 and searches a translation database for a translation of the communication included in communication data portion of the received message (e.g., communication data portion 502 in FIGS. 5A and 5B). For example, system 20 can search one or more databases stored in a data storage medium 26 for a translation of the communication included in the received message.

At decision block 312, system 20 determines if a translation is found. As will be understood by one of ordinary skill in the art, system 20 (and more particular processing device 24) determines if a translation is found if results are returned from the one or more data storage units 26 in response to a query.

If a translation is found at decision block 312, then processing device 24 moves to block 314 where a message is prepared for sending to the recipient. In some embodiments, the translation data, e.g., the translation of the original communication, is added to the received message such that the message to be transmitted to the recipient includes both the original communication (e.g., the English communication) and the translated communication (e.g., the Japanese translation of the English communication) in communication data portion. For example and referring to FIG. 5B, communication data portion 502 of message 500-2 includes a portion 512 for the original (i.e., the untranslated) message and a portion 514 for the translated message. Thus, if a translation is identified, translated message portion 514 is updated to include the translated version of the original message included in portion 512.

In some embodiments, the translated data (e.g., the Japanese translation of the English communication) replaces the received communication data (e.g., the English communication). For example and referring to FIG. 5A, the communication data portion 502 may be replaced in its entirety with the translated version of the original message.

Referring again to decision block 312 of FIG. 3, if a translation is not found, then processing device 24 of system 20 moves to block 316 where a translation service is accessed. For example and referring back to FIG. 1A, system 20 accesses translation service 72-1 via network 10 and the API 72-1 of translation service 72-1. System 20 requests translation service 72-1, which may include a more robust translation database than the translation database stored in the one or more data storage units 26 of system 20, to translate the communication included in the message received at system 20 from mobile device 100-1.

At decision block 318, system 20 determines if the translation service (i.e., translation service 72-1) was able to translate the communication. In some embodiments, the determination at block 318 is made in response to receiving a response from the translation service as will be understood by one of ordinary skill in the art.

If at decision block 318 it is determined that the translation service (i.e., translation service 70-1) was not able to provide the requested translation, then, if multiple translation services are available, system moves back to block 316. For example, if translation service 70-1 is not able to provide a translation of the communication included in the message received from mobile device 100-1, then another translation service (i.e., translation service 70-2) is queried as to whether the translation service can provide a translation for the communication. In this manner, multiple translation services can be used to translate a communication included in the message received by system 20 from mobile device 100-1.

If at decision block 318 it is determined that the translation service was able to provide a translation, then system 20 moves to block 314 and prepares a message for sending as described above. In some embodiments, system 20 will move to block 314 once all translation services have been exhausted even if a translation service was not available to provide a translation. Further, system 20 can be configured to store a copy of the translation in one or more data storage units 26 to improve the translation database maintained by system 20. Improving the translation database overtime advantageously enables communications to be translated faster and with less processing requirements as the third-party translation service does not need to be accessed.

As described above, the message to recipient (e.g., mobile device 100-2) is prepared at block 314 by either adding the translation data to the original communication received from the sender (e.g., mobile device 100-1) or the translation data replaces the original communication received from sender for sending to the recipient.

At block 308, the message is sent to the recipient device (e.g., mobile device 100-2) via network 10. In this manner, system 20 is configured to translate communications between users of mobile devices 100 (or computers 54) in real time.

The app running on the recipient computing device, such as mobile device 100-2, receives the message from system 20 and in response displays the communication to the user of mobile device 100-2. For example and referring again to FIG. 2E, a mobile device 100 displays the communications between users in area 230 of GUI 225. In some embodiments, both the original communication, such as the untranslated communication, and a translated version of the communication are provided to a user. For example, conversation bubble 231 includes an original communication portion 231a and another portion 231b that displays the translated communication.

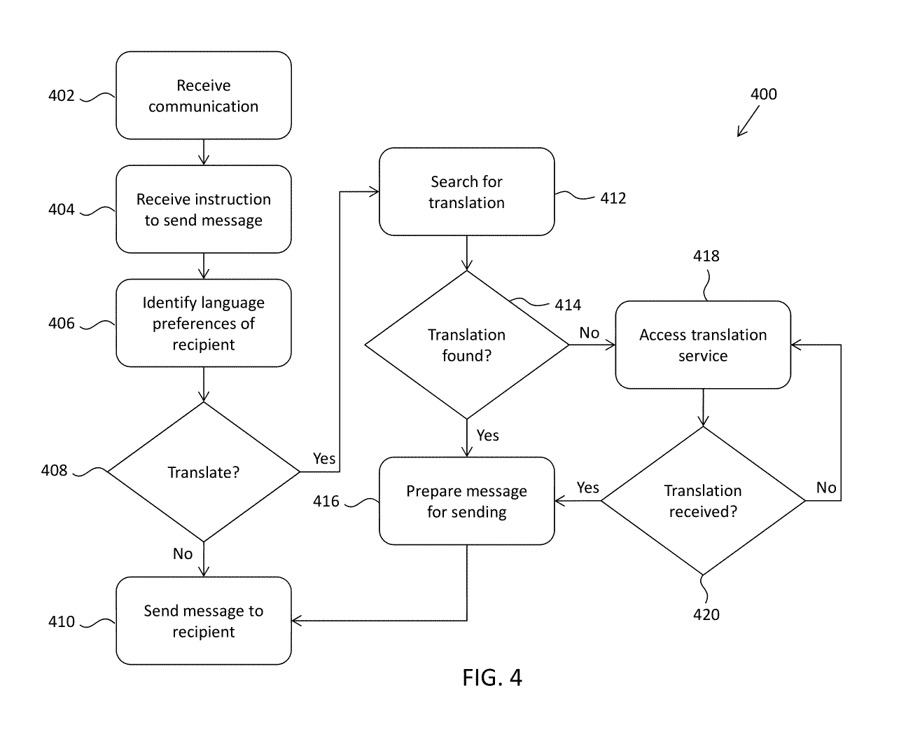

Various modifications can be made as will be apparent to one of ordinary skill in the art. For example, a mobile device 100 or computer 54 can be configured to perform certain functions of the method shown in FIG. 3. FIG. 4 illustrates one example of another method of translating communications in accordance with some embodiments. Although FIG. 4 is described as being performed by mobile device 100, one of ordinary skill in the art will understand that the steps can be performed by a computer 54.

At block 402, a communication is received. In some embodiments, a communication is input into a mobile device, such as mobile device 100-1, by a user using an input device to enter text into text entry field 226 presented to the user by the display 106 of mobile device 100-1. The input communication also can include data, such as a picture or other file type, that is attached by utilizing attachment button 227 and/or also can include an emoticon that is entered utilizing emoticon button 228.

At block 404, mobile device 100-1 receives an instruction to send a message, including the communication, to the contact identified in the GUI 225 presented to the user. The instruction to send the message is generated in response to the user pressing or clicking send button 229 in GUI 225 shown in FIG. 2E.

Referring again to FIG. 4, the language preference of the recipient is identified at block 406. In some embodiments, the language preference of the recipient is identified by mobile device 100-1 by searching one of main memory 104 and/or secondary memory 110 of mobile device 100-1 (FIG. 1B). For example, when a user adds a contact to his or her list of contacts, the profile information of the contact is stored in a data storage device, such as main memory and/or secondary memory 110. In some embodiments, the profile information is downloaded from system 20, and in some embodiments, the app being executed by processor(s) 102 is aware of the contact's (recipient's) language preferences. For example, in some embodiments, country and/or language identifiers 232-1, 232-2 are included in the contact entries 213 shown in FIG. 2C.

At decision block 408 in FIG. 4, processor(s) 102 of mobile device 100-determines whether the communication to be transmitted to the contact (recipient) is to be translated. In some embodiments, the determination as to whether the communication is to be translated is made based on whether the language preference of the sender, as determined by the profile of the user of mobile device 100-1, matches the language preference of the recipient of the message, i.e., the language preference of the contact.

If the communication is not to be translated, i.e., the No branch is taken at decision block 408, then at block 410 in FIG. 4 the communication is transmitted to the recipient (e.g., mobile device 100-2) in a message via network 10 (FIG. 1A). The untranslated communication is then displayed to the recipient, e.g., user of mobile device 100-2, as entered by the user of mobile device 100-1.

In some embodiments, the communication is included in a message, such as a message 500-1 illustrated in FIG. 5A or message 500-2 illustrated in FIG. 5B. Referring first to FIG. 5A, message 500-1 is generated by including the communication data in portion 502 and populating the sender language portion 508 and the recipient language portion 510. Further, mobile device 100-1 populates the translate data portion 506 to reflect that a translation is not needed. In embodiments using a data structure in accordance with FIG. 5B, mobile device 100-1 adds the communication to portion 512 and populates the translate data portion 506, sender language portion 508, and recipient language portion 510.

If the communication is to be translated, i.e., the Yes branch of decision block 408 in FIG. 4 is taken, then at block 412 a search is performed for a translation of the communication in accordance with language preferences identified by the communicating users (e.g., English to French, French to English, etc.). In some embodiments, the search is performed locally by processor(s) 102 by searching a translation database stored in main memory 104 and/or secondary memory 110 (FIG. 1B). In some embodiments, the search is performed by transmitting a request to system 20 via network 10 to search a translation database stored in one or more data storage units 26 (FIG. 1A). One of ordinary skill in the art will understand that the both a local search and an interrogation of system 20 can be performed at block 412.

At decision block 414 in FIG. 4, a decision is made as to whether a translation was found by the search. For example, in embodiments in which the search is performed locally, processors(s) 102 determine whether a translation is available in the translation database stored main memory 104 and/or secondary memory 110. In embodiments in which a request is transmitted from mobile device 100-1 to system 20 for system 20 to search for a translation, processor(s) 102 determine whether system 20 was able to translate the communication by parsing a response received from system 20 via network 10 (FIG. 1A).

If a translation is found at decision block 414 in FIG. 4, then processor(s) 102 move to block 416 where a message, including the translated communication, is prepared for sending to mobile device 100-2 (FIG. 1A). In some embodiments, the original text entered by the user in a first language (e.g., English) and the translation of the communication in a second language (e.g., French) are included in the message that is transmitted to mobile device 100-2. For example, a message 500-2 as shown in FIG. 5B can be utilized such that the original message is included in portion 512 of communication data portion 502, and the translated message is included in portion 514 of communication data portion 504.

One of ordinary skill in the art will understand that in some embodiments only the translated communication in the second language (e.g., French) is included in the message to mobile device 100-2. For example and referring to FIG. 5A, the original communication included in communication data portion 502 of message 500-1 is replaced with the translated communication.

Referring again to decision block 414 in FIG. 4, if a translation is not found, then processor(s) of mobile device 100-1 moves to block 418 where a translation service is accessed. For example and referring back to FIG. 1A, mobile device 100-1 accesses translation service 72-1 via network 10 in accordance with the API 72-1 of translation service 72-1 by processor(s) 102 causing communication interface 132 to transmit a message via network 10. Mobile device 100-1 requests translation service 72-1, which may include a more robust translation database than the translation database stored locally in main memory 104 and/or secondary memory 110 and/or a translation database stored by system 20 in the one or more data storage units 26, to translate the message input by a user using input device 128 (FIG. 1B).

At decision block 420 in FIG. 4, processors(s) 102 determine if the translation service (i.e., translation service 72-1) was able to translate the message. In some embodiments, the determination at block 420 is made in response to receiving a message from the translation service 72-1 as will be understood by one of ordinary skill in the art. In some embodiments, mobile device 100-1 can be configured to store a copy of the translation in main memory 104 and/or secondary memory 110 to improve the translation database maintained by mobile device 100-1. Improving the translation database overtime advantageously enables communications to be translated faster and with less processing requirements as the translation database maintained by system 20 and/or a third-party translation service do not need to be accessed.

If at decision block 420 it is determined that the translation service (i.e., translation service 70-1) was not able to provide the requested translation, then, if multiple translation services are available, processor(s) 102 move back to block 418 in FIG. 4. For example, if translation service 70-1 is not able to provide a translation of the communication, then another translation service (i.e., translation service 70-2) is queried as to whether the translation service 70-2 can provide a translation for the communication. In this manner, multiple translation services can be used to translate a communication input by a user using input device 128.

If at decision block 420 it is determined that the translation service was able to provide a translation, then processor(s) 102 move to block 416 and prepares a message, including the translation of the communication, for sending to mobile device 102-2 utilizing communication interface 132. In some embodiments, processor(s) 102 will move to block 416 once all translation services have been exhausted even if a translation service was not available to provide a translation. As described above, the message to recipient (i.e., mobile device 100-2) is prepared at block 416 by either adding the translation data (i.e., French communication) to the original communication (i.e., English communication) input by a user of mobile device 100-1 using input device 128. In some embodiments, the original communication entered by a user of mobile device 100-1 is replaced by the translated communication received from a translation service 70 for sending to mobile device 100-2.

At block 410, the message prepared by mobile device 100-1 is sent to mobile device 100-2 via network 10 and the respective communication interfaces 138 of mobile devices 100-1, 100-2. In this manner, a mobile device is configured to communicate translated communication to another mobile device or computer 54 in real time.

The app running on the recipient computing device, such as mobile device 100-2 or a computer 54, receives the message from mobile device 100-1 (or a computer 54) and in response displays the translated communication to the user of mobile device 100-2. For example and referring again to FIG. 2E, a mobile device 100 displays the translated communication and data transmitted between users in area 230 of GUI 225. In some embodiments, both the original communication, such as the untranslated communication, and a translated version of the communication are provided to a user. For example, conversation bubble 231 includes an original communication portion 231a and another portion 231b that displays the translated communication.

The disclosed systems and methods described above advantageously enable electronic communication between people using real-time language translation. In some embodiments, the real-time communication is provided using an intermediate processing device that stores user profiles, determines if communications between users need to be translated, and facilitates the translation of communications by accessing a database and/or a third-party translation service. In some embodiments, an intermediate processing device is configured to examine data structures to determine if communications included in messages being transmitted between two communicating devices are to be translated. The use of the data structures advantageously reduces the amount of processing required to facilitate the communication between different users.

In some embodiments, a system includes a non-transitory machine readable storage medium and a processor in communication with the non-transitory machine readable storage medium. The processor is configured to determine if a first message received from a first computing device intended for a second computing device includes a first communication to be translated. If the first communication is to be translated, the processor is configured to cause a second message to be generated based on the first message. The second message includes a second communication in the form of a translated version of the first communication. The processor is configured to cause one of the first message and the second message to be transmitted to the second computing device. At least one of the first communication and the translated version of the first communication is to be displayed to a user of the second computing device.

In some embodiments, the processor is configured to cause a search of a database stored in the non-transitory machine readable medium for a translation of the first communication if the first communication is to be translated.

In some embodiments, the processor is configured to cause a translation service to be accessed if the translation of the first communication is not available in the database.

In some embodiments, the processor is configured to cause a translation service to be accessed for a translation of the first communication if the first communication is to be translated.

In some embodiments, the processor is configured to determine if the first communication is to be translated based on a comparison of first user profile data associated with the first computer device and second user profile data associated with the second computer device.

In some embodiments, the first and second user profile data are stored in the non-transient machine readable storage medium.

In some embodiments, the receipt of the first message and the transmission of the one of the first message and the second message are performed in real time.

In some embodiments, the first message is transmitted to the second computing device if a language preference identified in a first user profile associated with the first computing device matches a language preference identified in a second user profile associated with the second computing device.

In some embodiments, the second message includes the first communication and the translated version of the first communication.

In some embodiments, a method includes receiving a first message from a first computing device, and determining, at a third computing device, if the first message includes a first communication to be translated. The first message is intended for a second computing device. If the first communication is to be translated, a second message based on the first message is generated at the third computing device. The second message includes a translated version of the first communication. One of the first message and the second message is transmitted from the third computing device to the second computing device. At least one of the first communication and the translated version of the first communication is to be displayed to a user of the second computing device.

In some embodiments, a database maintained at the third computing device is searched for the translation of the first communication if the first communication is to be translated.

In some embodiments, if the translation is not available in the database, a request from the third computing device is transmitted to a fourth computing device to provide a translation of the first communication, and a response to the request is received at the third computing device. The response includes the translated version of the first communication.

In some embodiments, a request is transmitted from the third computing device to a fourth computing device to provide a translation of the first communication, and a response to the request is received at the third computing device. The response includes the translated version of the first communication.

In some embodiments, determining, at the third computing device, if the first communication is to be translated includes comparing a language preference of a user profile associated with the first computing device with a language preference of a user profile associated with the second computing device.

In some embodiments, if the language preference of the user profile associated with the first computing device matches the language preference of the user profile associated with the second computing device, the third computing device determines that the first communication is not to be translated.

In some embodiments, the second message includes the first communication and the translated version of the first communication.

In some embodiments, receiving the first message and transmitting one of the first message and the second message is performed in real time.

In some embodiments, determining, at the third computing device, if the first communication is to be translated includes examining a data structure included in the first message.

In some embodiments, a method includes determining into which language the first communication is to be translated by examining the data structure.

In some embodiments, the first message is transmitted to the second computing device if a language preference identified in a first user profile associated with the first computing device matches a language preference identified in a second user profile associated with the second computing device.

The disclosed systems and methods can be embodied, at least partially, in the form of methods and apparatus for practicing those methods. The disclosed systems and methods can also be embodied in the form of program code embodied in tangible media, such as floppy diskettes, CD-ROMs, DVD-ROMs, Blu-ray disks, hard drives, or any other machine-readable storage medium, wherein, when the program code is loaded into and executed by a machine, such as a computer, the machine becomes an apparatus for practicing the method. The disclosed systems and methods can also be embodied, at least partially, in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the method. When implemented on a general-purpose processor, the program code segments combine with the processor to provide a unique device that operates analogously to specific logic circuits.

Although the disclosed systems and methods have been described in terms of exemplary embodiments, they are not limited thereto. Rather, the appended claims should be construed broadly, to include other variants and embodiments of the disclosed systems and methods, which may be made by those skilled in the art without departing from the scope and range of equivalents of the disclosed systems and methods.

What is claimed is:

1. A system, comprising
a non-transitory machine readable storage medium; and
a processor in communication with the non-transitory machine readable storage medium, the processor configured to
determine if a first message received from a first computing device intended for a second computing device includes a first communication to be translated;
if the first communication is to be translated, cause a second message to be generated based on the first message, the second message including a second communication in the form of a translated version of the first communication; and
cause one of the first message and the second message to be transmitted to the second computing device,
wherein at least one of the first communication and the translated version of the first communication is to be displayed to a user of the second computing device.

2. The system of claim 1, wherein the processor is configured to cause a search of a database stored in the non-transitory machine readable medium for a translation of the first communication if the first communication is to be translated.

3. The system of claim 2, wherein the processor is configured to cause a translation service to be accessed if the translation of the first communication is not available in the database.

4. The system of claim 1, wherein the processor is configured to cause a translation service to be accessed for a translation of the first communication if the first communication is to be translated.

5. The system of claim 1, wherein the processor is configured to determine if the first communication is to be translated based on a comparison of first user profile data associated with the first computer device and second user profile data associated with the second computer device.

6. The system of claim 5, wherein the first and second user profile data are stored in the non-transient machine readable storage medium.

7. The system of claim 1, wherein the receipt of the first message and the transmission of the one of the first message and the second message are performed in real time.

8. The system of claim 1, wherein the first message is transmitted to the second computing device if a language preference identified in a first user profile associated with the first computing device matches a language preference identified in a second user profile associated with the second computing device.

9. The system of claim 1, wherein the second message includes the first communication and the translated version of the first communication.

10. A method, comprising:
receiving a first message from a first computing device, the first message intended for a second computing device;
determining, at a third computing device, if the first message includes a first communication to be translated;
if the first communication is to be translated, generating a second message based on the first message at the third computing device, the second message including a translated version of the first communication; and
transmitting one of the first message and the second message from the third computing device to the second computing device,
wherein at least one of the first communication and the translated version of the first communication is to be displayed to a user of the second computing device.

11. The method of claim 10, further comprising searching a database maintained at the third computing device for the translation of the first communication if the first communication is to be translated.

12. The method of claim 11, further comprising, if the translation is not available in the database,
transmitting, from the third computing device to a fourth computing device, a request to provide a translation of the first communication; and
receiving, at the third computing device, a response to the request,
wherein the response includes the translated version of the first communication.

13. The method of claim 10, further comprising
transmitting, from the third computing device to a fourth computing device, a request to provide a translation of the first communication; and
receiving, at the third computing device, a response to the request,
wherein the response includes the translated version of the first communication.

14. The method of claim 10, wherein determining, at the third computing device, if the first communication is to be translated includes comparing a language preference of a user profile associated with the first computing device with a language preference of a user profile associated with the second computing device.

15. The method of claim 14, wherein, if the language preference of the user profile associated with the first computing device matches the language preference of the user profile associated with the second computing device, the third computing device determines that the first communication is not to be translated.

16. The method of claim 10, wherein the second message includes the first communication and the translated version of the first communication.

17. The method of claim 10, wherein receiving the first message and transmitting one of the first message and the second message is performed in real time.

18. The method of claim 10, wherein determining, at the third computing device, if the first communication is to be translated includes examining a data structure included in the first message.

19. The method of claim 18, further comprising determining into which language the first language is to be translated by examining the data structure.

20. The method of claim 10, wherein the first message is transmitted to the second computing device if a language preference identified in a first user profile associated with the first computing device matches a language preference identified in a second user profile associated with the second computing device.
